(19) United States
(12) Patent Application Publication
(10) Pub. No.: US 2023/0049071 A1
(43) Pub. Date: Feb. 16, 2023

(54) EXTRUDED FLUORESCENT FILMS

(71) Applicant: UbiQD, Inc., Los Alamos, NM (US)

(72) Inventors: HUNTER MCDANIEL, Los Alamos, NM (US); MATTHEW BERGREN, Los Alamos, NM (US); AARON JACKSON, Los Alamos, NM (US)

(21) Appl. No.: 17/790,116

(22) PCT Filed: Dec. 30, 2020
(86) PCT No.: PCT/US20/67587

§ 371 Date: Jun. 29, 2022

Related U.S. Application Data
(60) Provisional application No. 62/955,258, filed on Dec. 30, 2019.

(51) Int. Cl. C09K 11/02; C09K 11/62; C08F 210/02; C08F 216/06; C08K 9/02; C08J 5/18

(52) U.S. Cl. CPC C09K 11/02; C09K 11/623; C08F 210/02; C08F 216/06; C08K 9/02; C08J 5/18; B82Y 20/00

(57) ABSTRACT

Optical elements and compositions are provided which include an extruded polymer, and a plurality of fluorophores disposed within. The fluorescent compositions have quantum yields greater than 50% and are stable in performance over long durations of time under oxygen, moisture, and light exposure. In some embodiments, the extruded polymer is prepared as pellets, microparticles, nanoparticles, or films.

### CROSS-REFERENCE TO RELATED APPLICATIONS

This application is a national stage filing of PCT/US20/67587, filed on Dec. 30, 2020, having the same inventors and the same title, and which is incorporated herein by referenced in its entirety; which claims the benefit of priority from U.S. provisional application No. 62/955,258, filed Dec. 30, 2019, which is incorporated herein by reference in its entirety.

### FIELD OF THE DISCLOSURE

The present disclosure relates generally to fluorescent materials and extruded films, and more specifically to co-extruded fluorescent materials and polymers that are robust against oxygen and/or moisture ingress and that are stable under long-term exposure to light.

### BACKGROUND OF THE DISCLOSURE

Luminescent films are particularly useful in agriculture to modify incoming light for improved crop growth. They may also be used in other applications, including energy conversion and displays. One significant challenge associated with luminescent films is their tendency to degrade under high intensity light and in the presence of oxygen or moisture. Oxygen and moisture diffuse through most film materials. The choice and structure of the material may limit that diffusion and may minimize at least one part of the degradation mechanism. Multi-layer film structures may be utilized to allow different film properties to be optimized separately.

Extrusion is a widely used technique in the fabrication of agricultural films, and is commonly used to prepare greenhouse films with up to seven layers. Various polymers have been utilized in extrusion techniques, including acrylics, polyethylene (PE), ethylene vinyl acetate (EVA), and ethylene vinyl alcohol (EVOH).

Quantum dots (QDs) are exemplary fluorescent materials that have the potential to modify light spectra to improve application performance. A good example of this is in agriculture, where QDs are utilized to create the lighting conditions that are most conducive to plant growth. Examples of agricultural films containing QDs are disclosed, for example, in commonly assigned WO2018209000A1 (McDaniel et al.), entitled “Luminescent Optical Elements for Agricultural Applications”.

### BRIEF DESCRIPTION OF THE DRAWINGS

FIG. 1 is a schematic illustration of a particular, non-limiting embodiment of a film in accordance with the teachings herein in which a plurality of fluorophores are embedded in a single layer barrier composite.

FIG. 2 is a schematic illustration of a particular, non-limiting embodiment of a film in accordance with the teachings herein in which a 3-layer film structure is used to protect an inner layer. The inner layer 1 contains fluorophores 2 and the outer layers 3 comprise polymer films engineered for low OTR and WVTR. The middle layer contains between 0.1 and 10 wt % fluorophores. The outer layers contain ethylene vinyl alcohol polymer copolymer with high ethylene content to minimize water uptake and oxygen diffusion.

FIG. 3 is a schematic illustration of a particular, non-limiting embodiment of a film in accordance with the teachings herein that contains fluorophores 2 in a central polymer matrix 1 sandwiched between layers of low OTR polymer 3 and layers of low WVTR polymer 4. The low OTR polymer is typically an ethylene vinyl alcohol copolymer or similar material. However, the vinyl alcohol groups absorb water and have reduced OTR under high humidity environments. As a result, polymer 3 is contained within a low WVTR polymer 4 such as polyethylene (LLDPE, LDPE, or other), fluorinated polyethylene, ethylene vinyl acetate, or similar material.

FIG. 4 is a schematic illustration of a particular, non-limiting embodiment of a film in accordance with the teachings herein that contains separate low OTR and low WVTR polymers. In this embodiment, the fluorophores 2 are encapsulated in an inner polymer 1 and incorporated in between two polymer laminates 5, where each laminate contains a low OTR 3 polymer disposed between one or two low WVTR 4 polymers. This arrangement allows for simpler manufacture and handling of polymer films that are symmetric. The final laminate between the low OTR laminate 5 and inner polymer 1 can be made using a roll-2-roll processing technique or extrusion. In some embodiments, the outer layers 4 of the laminate may contain additives for light stabilization 6, such as hindered amine light stabilizers (HALS), UV absorbers and anti-oxidants. These materials could also be used to further protect the QDs.

FIG. 5 is a plot of the PL intensity of two extruded polymers over time under UV light exposure. The QD-EVA sample degraded in less than 2 hours, whereas the QD-EVOH copolymer sample did not shown any signs of degradation over more than 100 hours when exposed to the same conditions.

### SUMMARY OF THE DISCLOSURE

In one aspect, optical elements and compositions are provided which include an extruded polymer, and a plurality of fluorophores disposed within. The fluorescent compositions have quantum yields greater than 50% and are stable in performance over long durations of time under oxygen, moisture, and light exposure. Said extruded film contains at least one layer having at least 1 wt % ethylene vinyl alcohol polymer copolymer. In some embodiments, the extruded polymer is prepared as pellets, microparticles, nanoparticles, or films.

### DETAILED DESCRIPTION

Polymeric films are the simplest form factor for QDs. However, QDs are known to degrade when exposed to light and oxygen for long durations of time, and films generally offer a high surface area for oxygen diffusion. Few polymers limit oxygen diffusion on their own. Frequently, polymers require a ceramic coating in order to achieve a low oxygen transmission rate (OTR). However, this process is costly and limits film widths.

Food grade barrier films could potentially solve this problem, but they are not engineered to be exposed to outdoor environmental conditions. Silage films have a similar make-up, but usually have a large fraction of pigment that renders them opaque. Typically, food grade barrier films have several layers, where each layer is chosen for to provide good water vapor transmission rate (WVTR) or oxygen transmission rate (OTR) properties (but typically not both). By building up those layers, a polymer with good OTR and WVTR may be produced. Moreover, since the manufacturing method includes blow molding and extrusion, the materials are typically less expensive.

### 1. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly indicates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure relates. Suitable methods and compositions are described herein for the practice or testing of the compositions, systems and methodologies described herein. However, it is to be understood that other methods and materials similar or equivalent to those described herein may be used in the practice or testing of these compositions, systems and methodologies. Consequently, the compositions, materials, methods, and examples disclosed herein are illustrative only, and are not intended to be limiting. Other features of the disclosure will be apparent to those skilled in the art from the following detailed description and the appended claims.

Unless otherwise indicated, all numbers expressing quantities of components, percentages, temperatures, times, and so forth, as used in the specification or claims are to be understood as being modified by the term “about.” Unless otherwise indicated, non-numerical properties such as colloidal, continuous, crystalline, and so forth as used in the specification or claims are to be understood as being modified by the term “substantially,” meaning to a great extent or degree. Accordingly, unless otherwise indicated implicitly or explicitly, the numerical parameters and/or non-numerical properties set forth are approximations that may depend on the desired properties sought, the limits of detection under standard test conditions or methods, the limitations of the processing methods, and/or the nature of the parameter or property. When directly and explicitly distinguishing embodiments from discussed prior art, the embodiment numbers are not approximations unless the word “about” is recited.

Photoluminescence (PL): The emission of light (electromagnetic radiation, photons) after the absorption of light. It is one form of luminescence (light emission) and is initiated by photoexcitation (excitation by photons).

Toxic: Denotes a material that can damage living organisms due to the presence of phosphorus or heavy metals such as cadmium, lead, or mercury.

Quantum Dot (QD): A nanoscale particle that exhibits size-dependent electronic and optical properties due to quantum confinement. The quantum dots disclosed herein preferably have at least one dimension less than about 50 nanometers. The disclosed quantum dots may be colloidal quantum dots, i.e., quantum dots that may remain in suspension when dispersed in a liquid medium. Some of the quantum dots which may be utilized in the compositions, systems and methodologies described herein are made from a binary semiconductor material having a formula MX, where M is a metal and X typically is selected from sulfur, selenium, tellurium, nitrogen, phosphorus, arsenic, antimony or mixtures thereof. Exemplary binary quantum dots which may be utilized in the compositions, systems and methodologies described herein include CdS, CdSe, CdTe, PbS, Pb Se, PbTe, ZnS, ZnSe, ZnTe, InP, InAs, Cu₂S, and In₂S₃. Other quantum dots which may be utilized in the compositions, systems and methodologies described herein are ternary, quaternary, and/or alloyed quantum dots including, but not limited to, ZnSSe, ZnSeTe, ZnSTe, CdSSe, CdSeTe, HgSSe, HgSeTe, HgSTe, ZnCdS, ZnCdSe, ZnCdTe, ZnHgS, ZnHgSe, ZnHgTe, CdHgS, CdHgSe, CdHgTe, ZnCdSSe, ZnHgSSe, ZnCdSeTe, ZnHgSeTe, CdHgSSe, CdHgSeTe, CuInS₂, CuInSe₂, CuInGaSe₂, CuInZnS₂, CuZnSnSe₂, CuIn(Se,S)₂, CuInZn(Se,S)₂, and AgIn(Se,S)₂ quantum dots, although the use of non-toxic quantum dots is preferred. Embodiments of the disclosed quantum dots may be of a single material, or may comprise an inner core and an outer shell (e.g., a thin outer shell/layer formed by any suitable method, such as cation exchange). The quantum dots may further include a plurality of ligands bound to the quantum dot surface.

Quantum Yield (QY): The ratio of the number of emitted photons to the number of absorbed photons for a fluorophore.

Fluorophore: a material which absorbs a first spectrum of light and emits a second spectrum of light.

Stokes shift: the difference in energy between the positions of the absorption shoulder or local absorption maximum and the maximum of the emission spectrum.

Emission spectrum: Those portions of the electromagnetic spectrum over which a photoluminescent material exhibits photoluminescence (in response to excitation by a light source) whose amplitude is at least 1% of the peak PL emission.

Polymer: A large molecule, or macromolecule, composed of many repeated subunits. Polymers range from familiar synthetic plastics such as polystyrene or poly(methyl methacrylate) (PMMA), to natural biopolymers such as DNA and proteins that are fundamental to biological structure and function. Polymers, both natural and synthetic, are created via polymerization of many small molecules, known as monomers. Exemplary polymers include poly(methyl methacrylate) (PMMA), polystyrene, ionoplasts, silicones, epoxy resins, and nail polish.

Self-absorption: The percentage of emitted light from a plurality of fluorophores that is absorbed by the same plurality of fluorophores. Some quantum dots, including CuInS₂, CuInSe₂, CuInGaSe₂, CuInZnS₂, CuZnSnSe₂, CuIn(Se,S)₂, CuInZn(Se,S)₂, and AgIn(Se,S)₂ and related compounds, are known to have uniquely low self-absorption.

### 2. Description of Specific Embodiments

It is a goal of the present disclosure to create a low-cost extruded fluorescent film that maintains its optical properties after long-term light exposure in the presence of oxygen and/or moisture. It has previously been demonstrated that ‘electronics grade’ barrier films can protect fluorophores; however, this approach is expensive, and does not scale well. By utilizing extruded polymers with barrier properties (preferably ethylene vinyl alcohol polymer copolymers), various fluorophores (including, but not limited to, quantum dots) may be rendered significantly more stable under light exposure in the presence of oxygen or moisture.

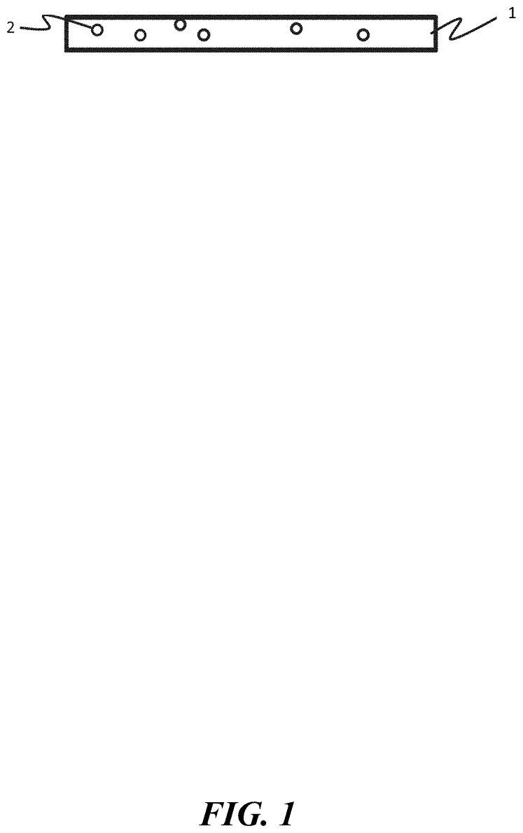

FIG. 1 depicts a particular, non-limiting embodiment of a single layer structure of the type disclosed herein. In the particular embodiment depicted, a single layer film structure is used to protect the fluorophores. The layer 1 contains CuInS₂/ZnS QDs 2 with peak emission at 600 nm. Layer 1 comprises polymer(s) engineered for low oxygen transmission rate (OTR) and low water vapor transmission rate (WVTR). Layer 1 contains between 0.1 and 10 wt % fluorophores and consists of ethylene vinyl alcohol polymer copolymer with ethylene content of 20-50% to minimize water uptake and oxygen diffusion. After over 2 weeks under blue light at 50° C. (accelerated aging conditions), the film was found to maintain at least 90% of its quantum yield (QY), compared to 0% for a polymer that has not been engineered for low OTR. In some embodiments, the QDs have vinyl alcohol or ethylene derivatives chemically bonded on to their surfaces to enhance solubility of in the matrix and further limit oxygen or water ingress. The polymer may take various form factors. Thus, for example, the polymer may be in the form of a film (which may be planar or non-planar), beads, pellets, or particles of various dimensions. By way of specific example, the polymer may be shaped as small 10 nm-1000 μm sized particles. Ideally, the said polymer layer 1 has an OTR value of less than 5 cm³ per m² per day at 50% relative humidity and 20° C. for a 1 mil thick film. Additionally, said polymer layer 1 should have a WVTR value of less than 100 g per m² per day at 90% relative humidity and 40° C. for a 1 mil thick film.

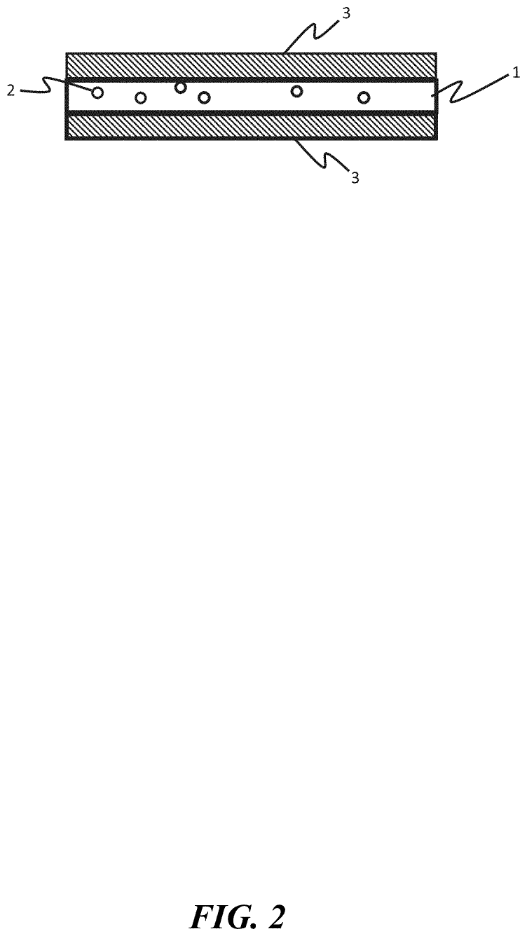

FIG. 2 depicts another particular, non-limiting embodiment of a multilayer structure of the type disclosed herein. The multilayer structure in this embodiment is a 3-layer film structure designed to protect the inner layer. The inner layer 1 contains CuInS₂/ZnS QDs 2 with a peak emission at 600 nm and the outer layers 3 comprise polymer films which are engineered for low OTR and WVTR. The inner layer 1 contains between 0.1 and 10 wt % fluorophores. The outer layers 3 comprise ethylene vinyl alcohol polymer copolymer with high ethylene content (e.g., preferably at least 20% molar fraction of ethylene, more preferably between 20 and 70% molar fraction of ethylene, and most preferably between 20 and 50% molar fraction of ethylene) to minimize water uptake and limit oxygen diffusion. After a period of more than 2 weeks under blue light at 50° C. (accelerated aging conditions), the film maintained 90% of its QY compared to 0% for a polymer that has not been engineered for low OTR. Ideally, the said polymer layer 3 has an OTR value of less than 5 cm³ per m² per day at 50% relative humidity and 20° C., and a WVTR value of less than 100 g per m² per day at 90% relative humidity and 40° C., for a 1 mil thick layer.

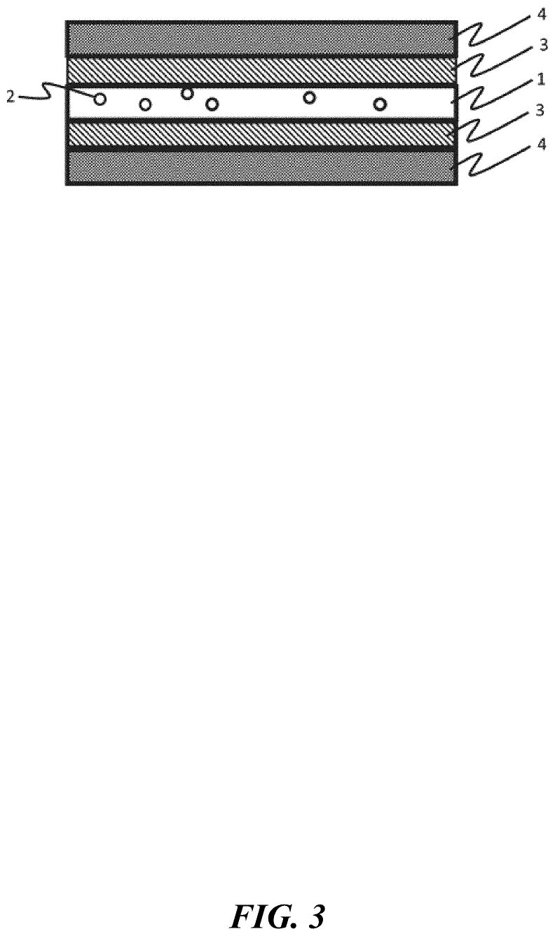

FIG. 3 depicts another particular, non-limiting embodiment of a multilayer structure of the type disclosed herein. The multilayer structure depicted therein contains an inner layer 1 comprising CuInS₂/ZnS QDs 2 with peak emission at 600 nm disposed in a polymer matrix. The inner layer 1 is sandwiched between layers of low OTR polymer 3 and layers of low WVTR polymer 4. The low OTR polymer is typically an ethylene vinyl alcohol copolymer or similar material. However, the vinyl alcohol groups absorb water and reduce the OTR in high humidity environments. As a result, polymer 3 is contained within a low WVTR polymer 4 such as polyethylene (LLDPE, LDPE, or other suitable polyethylenes), fluorinated polyethylene or similar materials. In this configuration and under blue light and 50° C. (accelerated aging conditions), the film was found to maintain 100% of its QY for over 2 weeks. For comparison, the same QDs contained in a 3-layer film engineered for low OTR maintained only 90% of their QY, and even then only in low humidity conditions. By comparison, QDs disposed between polycarbonate sheets were found to retain none of their QY after 2 weeks under the same conditions. Ideally, the said polymer layer 3 has an OTR value of less than 5 cm³ per m² per day at 50% relative humidity and 20° C. for a 1 mil thick film. Additionally, said polymer layer 4 should have a WVTR value of less than 100 g per m² per day at 90% relative humidity and 40° C. for a 1 mil thick film.

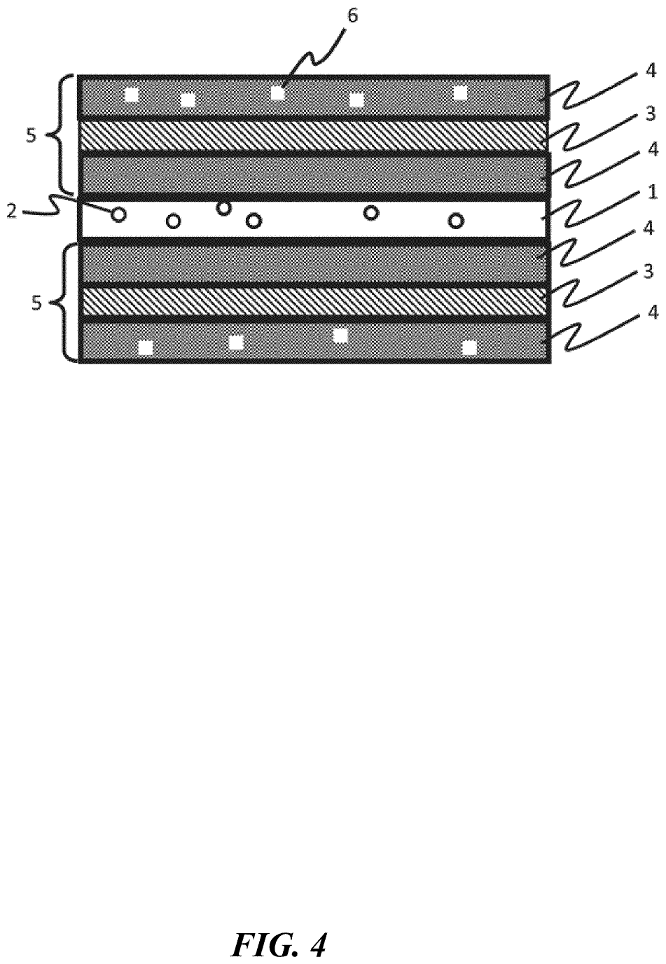

FIG. 4 depicts another particular, non-limiting embodiment of a multilayer structure of the type disclosed herein. In the multilayer structure depicted therein, the film contains separate low OTR and low WVTR polymers. The CuInS₂/ZnS QDs 2 (with a peak emission at 600 nm) are encapsulated in a polymer matrix 1 and sandwiched between two polymer laminates 5. Each laminate contains a low OTR 4 polymer disposed between two low WVTR 4 polymers. This structure allows for simpler manufacture and handling of polymer films that are symmetric. The final laminate between the low OTR laminates 5 and inner polymer 1 may be made using a roll-to-roll or extrusion processing technique. In some embodiments, the outer layers 4 of the laminate may contain additives for light stabilization 6 such as hindered amine light stabilizers (HALS), UV absorbers and anti-oxidants. These may also be used to further protect the QDs. In this configuration and under blue light and 50° C. (accelerated aging conditions), the QDs are found to maintain 100% of their initial QY for more than 2 weeks. Ideally, the said polymer layer 3 has an OTR value of less than 5 cm³ per m² per day at 50% relative humidity and 20° C. for a 1 mil thick film. Additionally, said polymer layer 4 should have a WVTR value of less than 100 g per m² per day at 90% relative humidity and 40° C. for a 1 mil thick film.

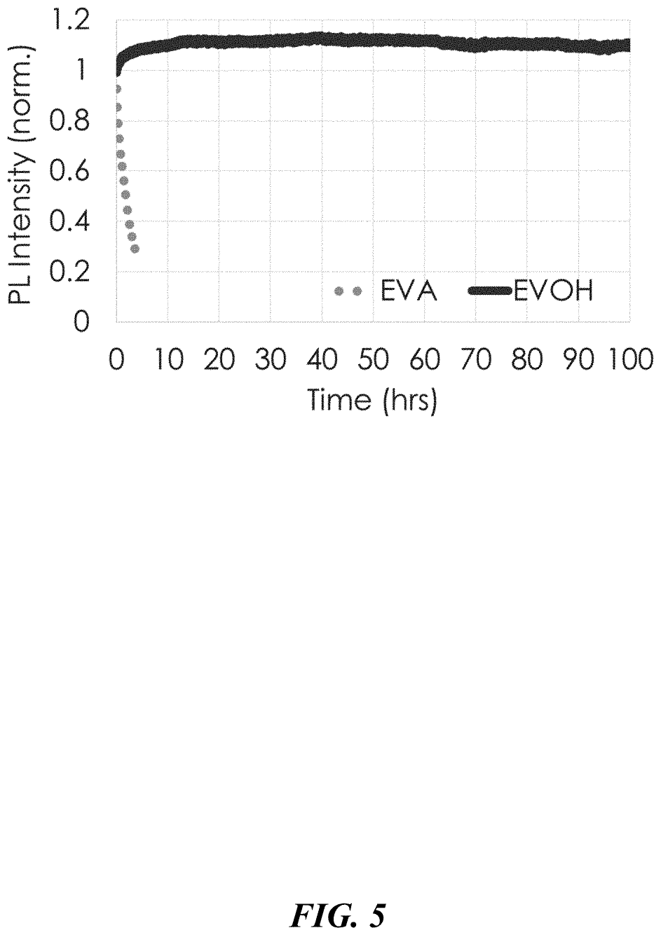

FIG. 5 depicts the relationship between the photostability of quantum dots embedded in two similar extruded polymer films (EVA vs EVOH copolymers). The EVA contained ˜87% wt % ethylene, and the EVOH contained ˜38 mol % ethylene. Films contained ˜3 wt % QD embedded in the polymer matrix (EVA or EVOH copolymer) were made from extruded pellets using a twin screw extruder at ˜200° C. and 50 RPM. Photostability measurements on said films were done at ˜50° C., ˜2.5× acceleration relative to full sunlight at 405 nm excitation under ambient atmosphere (relative humidity was approximately ≤20%). Photostability is determined based on the length of time it takes for the sample to degrade to 50% of the starting PL intensity. The EVA sample degraded in less than 2 hours whereas the EVOH sample did not shown any signs of degradation after more than 100 hours. Without wishing to be bound by theory, it is believed that the surprisingly large difference between the EVA and EVOH copolymers is likely due to the ˜10,000× higher OTR for EVA versus EVOH.

### 3. Additional Comments

Various modifications, substitutions, combinations, and ranges of parameters may be made or utilized in the compositions, devices and methodologies described herein.

For example, in some embodiments, the photoluminescence of the luminescent material may have a maximum intensity at wavelengths in the range of 400 nm to 2000 nm, more preferably in the range of 550 nm to 1700 nm, and most preferably in the range of 550 nm to 750 nm. In some embodiments, the fluorophores may emit a spectrum of light having full-width at maximum intensity that is greater than 1 nm, greater than 20 nm, greater than 30 nm, greater than 40 nm, greater than 100 nm, or greater than 200 nm. In other embodiments, the photoluminescence of the luminescent material may have a maximum intensity at wavelengths greater than 550 nm.

In some embodiments, the photoluminescence of the luminescent material may be characterized by a quantum yield of at least 30%, at least 50%, at least 70%, or at least 80%.

Various optical elements may be utilized in the optical paths of the devices and methodologies described herein. For example, in some embodiments, a spectrum selecting optical element may be placed in the optical path between the irradiated article and the incident sunlight. Such an optical element may include, for example, one or more elements selected from the group consisting of light filters, quantum dot films and colored glasses. A spectrum selecting optical element of this type may allow only a given portion of the spectrum to pass.

QDs and fluorophores of various composition may be utilized in the systems and methodologies disclosed herein. Some of these compositions have been noted above. In some embodiments of the systems and methodologies described herein, QDs and fluorophores having compositions selected from the group consisting of CuInS₂, CuInSe₂, AgInS₂, AgInSe₂, ZnS, ZnSe, CuInZnSeS, CuGaS₂, and alloys of the foregoing, may be utilized. However, in many embodiments of the systems and methodologies disclosed herein, the use of QDs and fluorophores having the composition CuInSeₓS₂₋ₓ/ZnS are preferred.

In some embodiments, two or more distinct types of quantum dots may be utilized in the systems, methodologies and compositions described herein. These quantum dots may be compositionally distinct. For example, the luminescent materials utilized herein may comprise a first type of quantum dot based on a first chemistry, and a second type of quantum dot based on a second chemistry which is distinct from the first chemistry. Thus, for example, the first type of quantum dot may comprise, for example, CuInS₂, while the second type of quantum dot may comprise AgInSe₂. Similarly, the luminescent materials described herein may comprise a first type of quantum dot based on a first set of dimensions (or distribution of dimensions) of the quantum dots, and a second type of quantum dot based on a second set of dimensions (or distribution of dimensions) of the quantum dots which is distinct from the first set of dimensions (or distribution of dimensions) of the quantum dots. Thus, for example, the first type of quantum dot may comprise generally spherical quantum dots having a first diameter (e.g., 10 nm), and the second type of quantum dot may comprise generally spherical quantum dots having a second diameter (e.g., 30 nm).

In preferred embodiments, optical elements are provided which include a polymer film containing at least one layer comprising an ethylene vinyl alcohol polymer copolymer. This copolymer preferably contains at least 20% molar fraction of ethylene, more preferably between 20 and 70% molar fraction of ethylene, and most preferably between 20 and 50% molar fraction of ethylene. In some embodiments and applications thereof, this amount of ethylene is found to impart high resistance to moisture and oxygen permeability in the resulting film or optical element, without compromising other desirable attributes of the film or optical element.

In embodiments of the optical elements and compositions disclosed herein, the polymers used in these elements to impart moisture or oxygen resistance may have various OTR and WVTR values, and these values may depend, for example, on the atmosphere the optical element or composition is likely to encounter during its use, on the choice of matrix material for the layer(s) containing the fluorophore(s), and on other such factors. Preferably, these polymers have an OTR value of less than 5 cm3 per m2 per day at 50% relative humidity and 20° C. for a 1 mil thick film, more preferably less than 1 cm3 per m2 per day at 50% relative humidity and 20° C. for a 1 mil thick film, and most preferably less than 0.1 cm3 per m2 per day at 50% relative humidity and 20° C. for a 1 mil thick film. Preferably, these polymers have a WVTR value of less than 100 g per m2 per day at 90% relative humidity and 40° C. for a 1 mil thick film, more preferably less than 50 g per m2 per day at 90% relative humidity and 40° C. for a 1 mil thick film, even more preferably less than 30 g per m2 per day at 90% relative humidity and 40° C. for a 1 mil thick film, and most preferably less than 5 g per m2 per day at 90% relative humidity and 40° C. for a 1 mil thick film.

The devices, structures and methodologies disclosed herein have frequently been described herein in reference to their use in medical applications in general, and in diffuse optical spectroscopy in particular. However, one skilled in the art will appreciate that these devices, structures and methodologies may be employed in various other applications as well including, for example, general lighting applications.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

Moreover, it is specifically contemplated that the features described in the appended claims may be arranged in different combinations or sub-combinations without departing from the scope of the present disclosure. For example, it is contemplated that features set forth in two or more claims may be combined into a single claim without departing from the scope of the present disclosure, whether or not the resulting combination of features is explicitly disclosed elsewhere in the appended claims or disclosure.

What is claimed is:

1. An optical element, comprising:
an extruded polymer film; and
a plurality of fluorophores disposed in said extruded polymer film;
wherein said fluorophores have a quantum yield greater than 50%, and wherein said polymer film contains at least one layer having at least 1 wt % ethylene vinyl alcohol polymer copolymer.

2. The optical element of claim 1, wherein said fluorophores emit a spectrum of light having a maximum intensity at wavelengths greater than 400 nm.

3. The optical element of claim 1, wherein said fluorophores are quantum dots.

4. The optical element of claim 1, wherein said fluorophores are quantum dots comprising a material selected from the group consisting of CuInS₂, CuInSe₂, AgInS₂, AgInSe₂, ZnS, ZnSe, and alloys of the foregoing.

5. The optical element of claim 1, further comprising polymers that have oxygen or water barrier properties, wherein said fluorophores are dispersed in a polymeric matrix, and wherein said polymeric matrix is distinct from the polymers having oxygen or water barrier properties.

6. The optical element of claim 1, wherein said polymer film comprises polymers selected from the group consisting of an acrylate, polyethylene, polycarbonate, polyester, polyvinyl butyral, ethylene vinyl acetate, ethylene vinyl alcohol, combinations of these polymers or other similar polymers.

7. The optical element of claim 1, wherein said polymer includes at least one layer that contains additives for stabilizing polymers against light degradation.

8. The optical element of claim 1, wherein said polymer includes at least one layer that contains anti-oxidants or other sacrificial additives for slowing oxygen ingress.

9. The optical element of claim 1, wherein said polymer film contains at least one layer having ethylene vinyl alcohol polymer copolymer containing at least 20% molar fraction of ethylene, containing a molar fraction of ethylene within the range of 20 to 70%, or containing a molar fraction of ethylene within the range of 20 to 50%.

10. The optical element of claim 1, wherein said polymer film contains at least one exterior layer containing a polymer selected from the group consisting of polyethylene and ethylene vinyl acetate.

11. The optical element of claim 1, wherein said polymer film has an OTR value of less than 5 cm³ per m² per day at 50% relative humidity and 20° C. for a 1 mil thick film.

12. The optical element of claim 1, wherein said polymer film has an WVTR value of less than 100 g per m² per day at 90% relative humidity and 40° C. for a 1 mil thick film.

13. A composition, comprising:
an extruded copolymer containing at least 1 mol % vinyl alcohol and at least 20 mol % ethylene; and
a plurality of fluorophores disposed in said extruded polymer;
wherein said fluorophores are present at greater than 0.5 mol %, and wherein said composition has a quantum yield greater than 50%.

14. The composition of claim 13, wherein said copolymer is composed of pellets of polymer with diameters between 0.1 mm and 1 cm.

15. The composition of claim 13, wherein said copolymer is composed of nano or micro particles of polymer with diameters within the range of 10 nm and 1000 μm.

16. The composition of claim 13, wherein said fluorophores are chemically bonded to at least one polymer group selected from the group consisting of ethylene and vinyl alcohol groups.

17. The composition of claim 13, wherein said fluorophores are quantum dots comprising a material selected from the group consisting of CuInS₂, CuInSe₂, AgInS₂, AgInSe₂, ZnS, ZnSe, and alloys of the foregoing.

18. The composition of claim 13, further comprising polymers that have oxygen or water barrier properties that protect the fluorophores from long term degradation.

19. The composition of claim 13, wherein said copolymer contains additives for stabilizing polymers against degradation.

20. The composition of claim 13, wherein said copolymer contains anti-oxidants or other sacrificial additives for slowing oxygen ingress.
